(19) United States
(12) Patent Application Publication
(10) Pub. No.: US 2011/0007637 A1
(43) Pub. Date: Jan. 13, 2011

(54) Indicating Current Connection Status of a Wireless Device

(75) Inventors: Michael C. Chen, San Jose, CA (US); Gregory S. Mercurio, Campbell, CA (US); Eric M. Trehus, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 12/499,072

(22) Filed: Jul. 7, 2009

(51) Int. Cl. H04L 12/24; H04B 17/00

(52) U.S. Cl. 370/252; 455/67.7; 455/41.2

(57) ABSTRACT

In one embodiments, a method includes determining a current connection status of a first wireless device with respect to one or more second wireless devices configured to communicate wirelessly by a particular wireless communication protocol. The current connection status of the first wireless device potentially being that the first wireless device has scanned for and found one or more available ones of the second wireless devices to connect wirelessly to but has not yet having established a wireless connection to any one of them or potentially being that the first wireless device is currently attempting to establish a wireless connection to one of the available ones of the second wireless devices. The method includes communicating for presentation to a user at the first wireless device a scan-result indicator if the first wireless device has scanned for and found one or more available ones of the second wireless devices to connect wirelessly to but has not yet established a wireless connection to any one of them and a connection-attempt indicator if the first wireless device currently is attempting to establish a wireless connection to one of the available ones of the second wireless devices.

### TECHNICAL FIELD

The present disclosure relates generally to wireless communication.

### BACKGROUND

A wireless device (such as, for example, a Wi-Fi mobile telephone) may display an indication of its connection status. If the wireless device has established a wireless connection (such as, for example, to a Wi-Fi access point (AP)) the wireless device may indicate that the wireless device has established a wireless connection and what the signal strength of the wireless connection is. For example, the wireless device may display a number of colored bars, with the number of colored bars displayed representing the signal strength of the wireless connection. If the wireless device has not established a wireless connection, the wireless device may indicate that the wireless device has not established a wireless connection, without providing any more information. For example, the wireless device may display zero colored bars.

### BRIEF DESCRIPTION OF THE DRAWINGS

FIG. 1 illustrates an example system for indicating current connection status of a wireless device.

FIGS. 2A-2B illustrate example current connection status indicators.

FIG. 3 illustrates an example method for indicating current connection status of a wireless device.

FIG. 4 illustrates an example computer system.

### DESCRIPTION OF EXAMPLE EMBODIMENTS

Overview

In one embodiment, a method includes determining a current connection status of a first wireless device with respect to one or more second wireless devices configured to communicate wirelessly by a particular wireless communication protocol. The current connection status of the first wireless device potentially being that the first wireless device has scanned for and found one or more available ones of the second wireless devices to connect wirelessly to but has not yet having established a wireless connection to any one of them or potentially being that the first wireless device is currently attempting to establish a wireless connection to one of the available ones of the second wireless devices. The method includes communicating for presentation to a user at the first wireless device a scan-result indicator if the first wireless device has scanned for and found one or more available ones of the second wireless devices to connect wirelessly to but has not yet established a wireless connection to any one of them and a connection-attempt indicator if the first wireless device currently is attempting to establish a wireless connection to one of the available ones of the second wireless devices.

Description

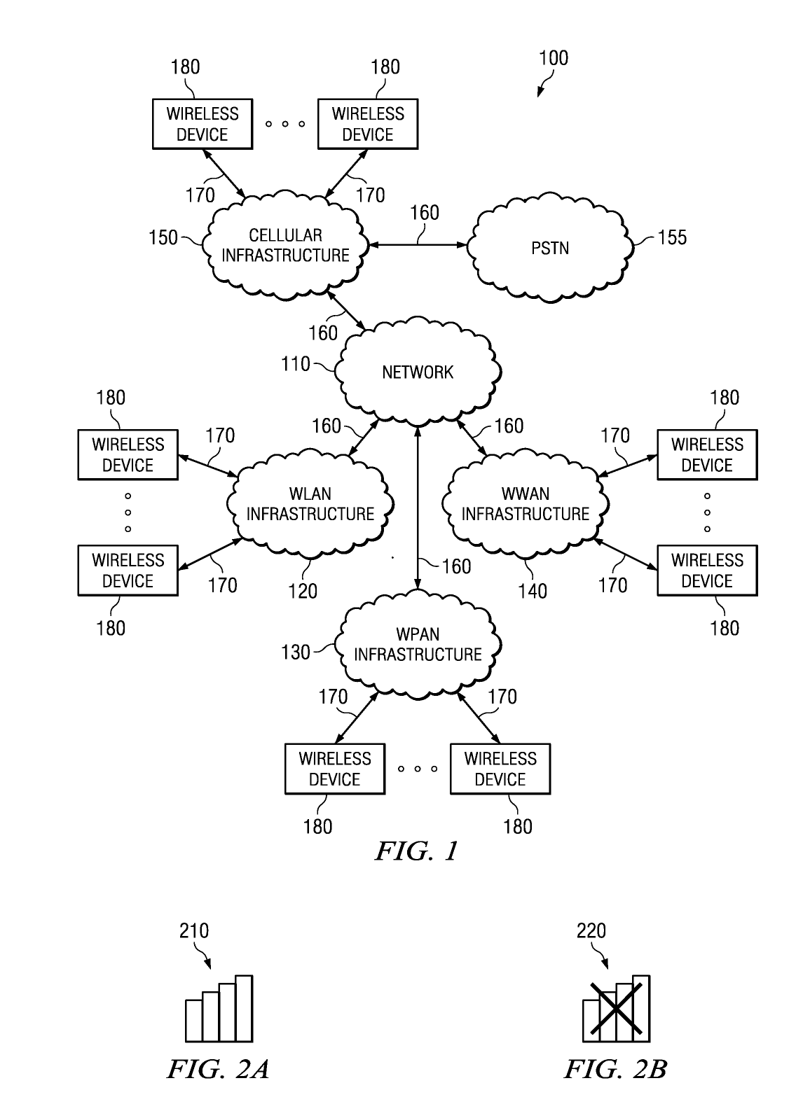

FIG. 1 illustrates an example system 100 for indicating current connection status of a wireless device 180. System 100 includes a network 110 coupled to a wireless local area network (WLAN) infrastructure 120, a wireless personal area network (WPAN) infrastructure 130, a wireless wide area network (WWAN) infrastructure 140, and a cellular infrastructure 150. Cellular infrastructure 150 is coupled to Public Switched Telephone Network (PSTN) 155. Although the present disclosure describes and illustrates particular infrastructures and networks in a particular arrangement with respect to each other, the present disclosure contemplates any suitable infrastructures or networks in any suitable arrangement with respect to each other. In particular embodiments, network 110 is an intranet, an extranet, a local area network (LAN), a metropolitan area network (MAN), a wide area network (WAN), a portion of the Internet, or another network 110 or a combination of two or more such networks 110. The present disclosure contemplates any suitable network 110. Network 110 may include one or more networks 110.

Links 160 couple infrastructures 120, 130, 140, and 150 to network 110 and infrastructure 150 to PSTN 155. In particular embodiments, one or more links 160 each include one or more wireline, wireless, or optical links. In particular embodiments, one or more links 160 each include an intranet, an extranet, a LAN, a MAN, a WAN, a portion of the Internet, or another link 160 or a combination of two or more such links 160. The present disclosure contemplates any suitable links 160. A link 160 may include one or more links 160. Links 160 need not be the same throughout system 100. One or more first links 160 may differ from one or more second links 160 in one or more respects. Links 170 wirelessly couple wireless devices 180 to infrastructures 120, 130, 140, and 150 across the air medium. The present disclosure contemplates any suitable links 170 wirelessly coupling any suitable wireless devices 180 to infrastructures 120, 130, 140, and 150 across the air medium. Moreover, the present disclosure contemplates any suitable wireless communication protocols for any suitable wireless communication across links 170. A link 170 may include one or more links 170. Links 170 need not be the same throughout system 100. One or more first links 170 may differ from one or more second links 170 in one or more respects.

A wireless device 180 may enable a user at client device 180 to access via one or more links 170 one or more of infrastructures 120, 130, 140, or 150, which may in turn client device 180 access to one or more services (such as, for example, telephony services) supported by one or more of infrastructure 120, 130, 140, or 150. Example wireless devices 180 include, but are not necessarily limited to workstations, notebook computer systems, desktop computer systems, tablet computer systems, personal digital assistants (PDAs), cellular telephones, Internet Protocol (IP) telephones, mobile Internet devices (MIDs), smartphones, video monitors, cameras, and computer peripherals, such as printers, keyboards, monitors, mice, or other computer peripherals. Other example wireless devices 180 include, but are not necessary limited to access points (APs), hot-spot detectors, pendent devices, and BLUETOOTH-enabled devices. The present disclosure contemplates any suitable wireless devices 180. A wireless device 180 may include one or more wireless devices 180. A wireless device 180 may communicate with one or more of infrastructures 120, 130, 140, or 150 via one or more links 170 using one or more particular communication protocols, according to particular needs. The present disclosure contemplates any suitable communication protocols for communicating with one or more of infrastructures 120, 130, 140, or 150 via one or more links 170. As an example and not by way of limitation, one or more wireless devices 180 may communicate with WLAN infrastructure 120 using one or more Institute of Electrical and Electronics Engineers (IEEE) 802.11 standards, such as 802.11a, 802.11b, 802.11g, or 802.11n. Reference to Wi-Fi may encompass IEEE 802.11, and vice versa, where appropriate. Similarly, reference to a Wi-Fi device may encompass an IEEE 802.11-enabled device, and vice-versa, where appropriate. As another example, one or more wireless devices 180 may communicate with WWAN infrastructure 140 using one or more IEEE 802.16 standards, such as 802.16d or 802.16e. Reference to WiMAX may encompass IEEE 802.16, and vice versa, where appropriate. Similarly, reference to a WiMAX device may encompass an IEEE 802.16-enabled device, and vice-versa, where appropriate. As yet another example, one or more wireless devices 180 may communicate with WPAN infrastructure using one or more BLUETOOTH protocols. In particular embodiments, particular wireless devices 180 may communicate with each other directly using one or more of one or more IEEE 802.11 standards, one or more IEEE 802.16 standards, or one or more BLUETOOTH protocols.

In particular embodiments, WLAN infrastructure 120 may include one or more servers, gateways, routers, hubs, firewalls, authentication devices, access points, repeater stations, bridges, or other components for communicating with one or more wireless devices 180. WLAN infrastructure 120 may implement one or more IEEE 802.11 standards. In particular embodiments, WLAN infrastructure 120 may include one or more peer-to-peer networks, ad-hoc networks, or shared mesh networks. The present disclosure contemplates any suitable WLAN infrastructure 120. WLAN infrastructure 120 may include one or more WLAN infrastructures 120, where appropriate.

A wireless device 180 may attempt to establish a wireless connection with WLAN infrastructure 120 over a link 170. As an example and not by way of limitation, during the attempt to establish the wireless connection with WLAN infrastructure 120, wireless device 180 may attempt to determine one or more identification parameters associated with WLAN infrastructure 120, such as a service set identifier (SSID). In particular embodiments, wireless device 180 may complete one or more authorization procedures during the attempt to establish a wireless connection with WLAN infrastructure 120. Examples of the authentication procedures may include, but are not limited to, authentication using the Wi-Fi Protected Access standards (WPA or WPA2), authentication using the Wired Equivalent Privacy standard (WEP), authentication using a Remote Authentication Dial In User Service (RADIUS) server, and authentication with a virtual private network (VPN). The attempt to establish a wireless connection with infrastructure 120 may also include activities directed towards establishing a network identifier for wireless device 180. Examples of a network identifier include one or more IP addresses and one or more port numbers. Each of these examples may be public or private as well as dynamic or static. Wireless device 180 may, in particular embodiments, transmit information, such as a Media Access Control (MAC) address in order to obtain the network identifier. In particular embodiments, wireless device 180 may use the Dynamic Host Configuration Protocol (DHCP) to obtain the network identifier.

Once the wireless connection has been established between wireless device 180 and WLAN infrastructure 120, in particular embodiments, wireless device 180 may be coupled to network 110 such that wireless device 180 may be able to send data to and receive data from network 110. This capability may provide wireless device 180 with the ability to provide one or more services to a user of wireless device 180. For example, wireless device 180 may provide the user with access to the Internet. As another example, wireless device 180 may be able to provide telephony services to the user by utilizing network 110 (such as voice-over-IP (VoIP) services).

In particular embodiments, WPAN infrastructure 130 may include one or more servers, gateways, routers, hubs, firewalls, authentication devices, access points, repeater stations, bridges, controllers, or other components or devices suitable to exchange data with one or more wireless devices 180. WPAN infrastructure 130 may, in particular embodiments, be implemented using one or more IEEE 802.15 standards or protocols. In particular embodiments, this may include one or more BLUETOOTH protocols (such as, for example, 1.1, 1.2, 2.0, or 3.0), as developed within the IEEE 802.15 family or the BLUETOOTH Special Interest Group (SIG). Various profiles, such as BLUETOOTH profiles, may be utilized within WPAN infrastructure 130. In particular embodiments, ultra-wideband (UWB), wireless Universal Serial Bus (USB), or BLUETOOTH low energy implementations may also be used in WPAN infrastructure 130. Other protocols implemented over BLUETOOTH or similar technologies may also be a part of WPAN infrastructure 130 such as Point-to-Point Protocol (PPP), Transmission Control Protocol (TCP) over Internet Protocol (IP), Object Exchange Protocol (OBEX), or Wireless Application Environment/Wireless Application Protocol (WAE/WAP). The present disclosure contemplates any suitable WPAN infrastructure 130. WPAN infrastructure 130 may include one or more WPAN infrastructures 130, where appropriate.

A wireless device 180 may attempt to establish a wireless connection with WPAN infrastructure 130 over a link 170. As an example and not by way of limitation, such an attempt to establish a wireless connection with infrastructure 130 may include determining what profiles are available within WPAN infrastructure 130. The attempt may also include determining an identifier associated with WPAN infrastructure 130, such as a Universally Unique Identifier (UUID). Wireless device 180 may exchange information with one or more nodes within WPAN infrastructure 130, such as a device name, device class, a list of services, device features, manufacturer information, protocols or standards used, or timing parameters (such as a clock offset). The attempt to establish a wireless connection may include pairing procedures. Such pairing procedures may include exchanging authentication information, such as a link key. Authentication procedures may include using public key cryptography methods.

In particular embodiments, once the wireless connection has been established between wireless device 180 and WPAN infrastructure 130, wireless device 180 may be coupled to network 110 such that wireless device 180 may be able to send data to and receive data from network 110. This capability may provide wireless device 180 with the ability to provide one or more services to a user of wireless device 180. For example, wireless device 180 may provide the user with access to the Internet. As another example, wireless device 180 may be able to provide telephony services to the user by utilizing network 110 (such as VoIP services).

In particular embodiments, WWAN infrastructure 140 may include one or more servers, gateways, routers, hubs, firewalls, authentication devices, access points, repeater stations, bridges, base stations, femto base stations, controllers, or other components or devices for communicating with one or more wireless devices 180 via one or more links 170. In particular embodiments, WWAN infrastructure 140 may be implemented using a variety of technologies, taken alone or in combination, such as Worldwide Interoperability for Microwave Access (WIMAX) and Long Term Evolution (LTE). WWAN infrastructure 140 may use packet-switched data networks or circuit-switched dial-up connections. In particular embodiments, protocols and or standards based on the IEEE 802.16 set of standards may be used. Architectures such as EPS (Evolved Packet System) and EPC (Evolved Packet Core) or SAE (System Architecture Evolution) may, in particular embodiments, also be used. The present disclosure contemplates any suitable WWAN infrastructure 140. WWAN infrastructure 140 may include one or more WWAN infrastructures 140, where appropriate.

A wireless device 180 may attempt to establish a wireless connection with WWAN infrastructure 140 over a link 170. As example and not by way of limitation, the attempt may include entering a ranging session with an entity within WWAN infrastructure 140. Wireless device 180 may also under one or more authentication procedures as part of the attempt to establish a wireless connection with WWAN infrastructure 140. Various forms of public key cryptography and encryption may be used as a part of the authentication procedures. In particular embodiments, various parameters may be exchanged between wireless device 180 and one or more entities within WWAN infrastructure 140. Such parameters may include device capabilities, network capabilities, synchronization or other timing parameters, channel or subchannel frequency information, as well as other parameters that may be necessary to establish a wireless connection between WWAN infrastructure 140 and wireless device 180.

In particular embodiments, once the wireless connection has been established between wireless device 180 and WWAN infrastructure 140 wireless device 180 may be coupled to network 110 such that wireless device 180 may be able to send data to and receive data from network 110. This capability may provide wireless device 180 with the ability to provide one or more services to a user of wireless device 180. For example, wireless device 180 may provide the user with access to the Internet. As another example, wireless device 180 may be able to provide telephony services to the user by utilizing network 110 (such as VoIP services).

In particular embodiments, cellular infrastructure 150 may include one or more servers, towers, gateways, home location registers, visitor location registers, routers, various cell types (such as macro, micro, pico, femto and umbrella), hubs, firewalls, authentication devices, access points, repeater stations, bridges, base stations, femto base stations, controllers, or other components or devices for communicating with one or more wireless devices 180. In particular embodiments, cellular infrastructure 150 may include one or more of the following technologies: Universal Mobile Telecommunications System (UMTS), General packet radio service (GPRS), code division multiple access (CDMA) and related technologies (i.e., CDMA2000), Global System for Mobile communications (GSM), Cellular Digital Packet Data (CDPD), Mobitex, High-Speed Packet Access (HSPA) family (i.e., HSDPA, HSPA+, etc.), or various other 3G technologies. PSTN 155 may also be coupled to or integrated with cellular infrastructure 150. Cellular infrastructure 150 may utilize PSTN 155 to route various types of communication sessions, such as, for example, telephone calls to landline telephones. The present disclosure contemplates any suitable cellular infrastructure 150. Cellular infrastructure 150 may include one or more cellular infrastructures 150, where appropriate.

A wireless device 180 may attempt to establish a wireless connection with cellular infrastructure 150 over a link 170. As an example and not by way of limitation, the attempt may include entering a ranging session with an entity within cellular infrastructure 150. Wireless device 180 may also under one or more authentication procedures as part of the attempt to establish a wireless connection with cellular infrastructure 150. Various forms of public key cryptography and encryption may be used as a part of the authentication procedures. In particular embodiments, various parameters may be exchanged between wireless device 180 and one or more entities within cellular infrastructure 150. Such parameters may include device capabilities, network capabilities, synchronization or other timing parameters, channel or subchannel frequency information, as well as other parameters that may be necessary to establish a wireless connection between cellular infrastructure 150 and wireless device 180. In particular embodiments, wireless device 180 may perform one or more registrations with one or more entities within cellular infrastructure 150. Such registrations may include sending information to a home location register or to a visitor location register.

In particular embodiments, once the wireless connection has been established between wireless device 180 and cellular infrastructure 150, wireless device 180 may be coupled to network 110 such that wireless device 180 may be able to send data to and receive data from network 110. This capability may provide wireless device 180 with the ability to provide one or more services to a user of wireless device 180. For example, wireless device 180 may provide the user with access to the Internet. As another example, wireless device 180 may be able to provide telephony services to the user by utilizing network 110 (such as VoIP services). PSTN infrastructure 155 may, in particular embodiments, be used to supplement the capabilities of the established wireless connection between the wireless device 180 and cellular infrastructure 150. For example, incoming or outgoing calls may be routed through PSTN 155.

FIGS. 2A-2B illustrate example current connection status indicators. Status representations 210 and 220 indicate to a user of a wireless device 180 a current connection status of wireless device 180 to an infrastructure 120, 130, 140, or 150 (or wireless network). Status representation 210 may be dynamic in that its appearance may change as the state of wireless device 180 changes. In particular embodiments, colors may be used to change the appearance of status representation 210 in a manner that reflects the state of wireless device 180. For example, one color (white or grey) may be present in status representation 210 to indicate that wireless device 180 detected that one or more networks are available while a different color (yellow) may be present when wireless device 180 attempts to establish a wireless connection with one of the available wireless networks. In particular embodiments, a different color (green) may be present in status representation 210 when a wireless connection has been established between wireless device 180 and a wireless network or wireless infrastructure. If wireless device 180 does not detect any available wireless networks, a different color (red) may be present in status representation 210.

The individual bars of status representation 210 may be filled (in particular embodiments, with the colors discussed above) to indicate parameters such as signal strength. For example, if wireless device 180 has detected that one or more networks are available, some or all of the individual bars of status representation 210 may be filled in to indicate the strength of the signals received from the network of the available networks that has the highest received signal quality. As another example, if wireless device 180 is attempting to establish a connection with a wireless network, some or all of the individual bars of status representation 210 may be filled in to indicate the strength of the signals received from that network.

The examples of dynamic representation given above may provide a user of wireless device 180 feedback as to what state wireless device 180 is in. Status representation 210 may also aid in troubleshooting problems with a wireless device 180. For example, a user of a wireless device 180 may be unable to connect to a wireless network and may contact a technician for assistance. The technician may be aided in ascertaining the cause of the user's problem by referencing status representation 210. It may be, for example, that status representation 210 has a color present that indicates that wireless device 180 is attempting to connect to a wireless network. This may serve to inform the technician that the device is properly detecting networks but is not able to connect to a wireless network. In such an example, the technician may then continue to pursue the problem by inquiring about the configuration in wireless device 180 with respect to connecting to a particular network.

As another example, a user of a wireless device 180 may report errors with the device to a technician while status representation 210 indicates (through having a particular color present, for example) that wireless device 180 has successfully connected to a wireless network. The technician may use this information to investigate other issues related to wireless device 180, such as software settings or server settings rather than exploring whether wireless device 180 has properly connected to a wireless network.

Status representation 220 indicates to a user of a wireless device 180 that wireless device 180 has not detected any available wireless networks. Variations of status representation 220 may also be used. For example, instead of placing an “X” over a set of bars, a single slash mark may be placed over some or all of the set of bars. In various embodiments, status representation 220 may include an icon of an antennae placed adjacent to the depicted bars with a slash mark placed over the antennae portion instead of, or in addition to, over the signal bars. Color may be used to enhance the appearance of status representation 220 as well. For example, the color red may be used in status representation 220 to help the user identify that there is a problem with the wireless connection, though the user may not know the exact meaning of status representation 220. Hence, in particular embodiments, an “X” or a single slash mark placed over a set of bars may be in a particular color, such as the color red. Status representation 220 may, in particular embodiments, aid technicians who are attempting to resolve problems with a wireless device 180 by informing them of the status of wireless device 180. This, in particular embodiments, may save the technician or the user of wireless device 180 time when troubleshooting the device.

Status representations 210 and 212 may be configured in a large variety of ways. Different icons may be used to represent the status of a wireless device 180. For example, each status of a wireless device 180 may be depicted using a different color or a different icon. In particular embodiments, status representations 210 and 212 may be audio files played for the user through wireless device 180 rather than or in addition to icons visually represented to a user of wireless device 180. The audio files may, for example, be short sound clips that represent different states of wireless device 180 (such as when wireless device 180 detects available networks and when wireless device 180 attempts to establish a wireless connection with the available networks). In particular embodiments, the sound clips may contain a voice stating the status of wireless device 180. The voice may be configured to speak in a language suitable to the user of wireless device 180. Exemplary statements include “networks detected,” “connection established,” and “connecting to the network.” Such forms of representations may provide a wireless device 180 greater accessibility to those with disabilities such as sight disabilities. The examples discussed merely illustrate the potential forms status representations 210 and 212 may take and are not meant to be limiting. Suitable variations and substitutions may be made to status representations 210 and 212.

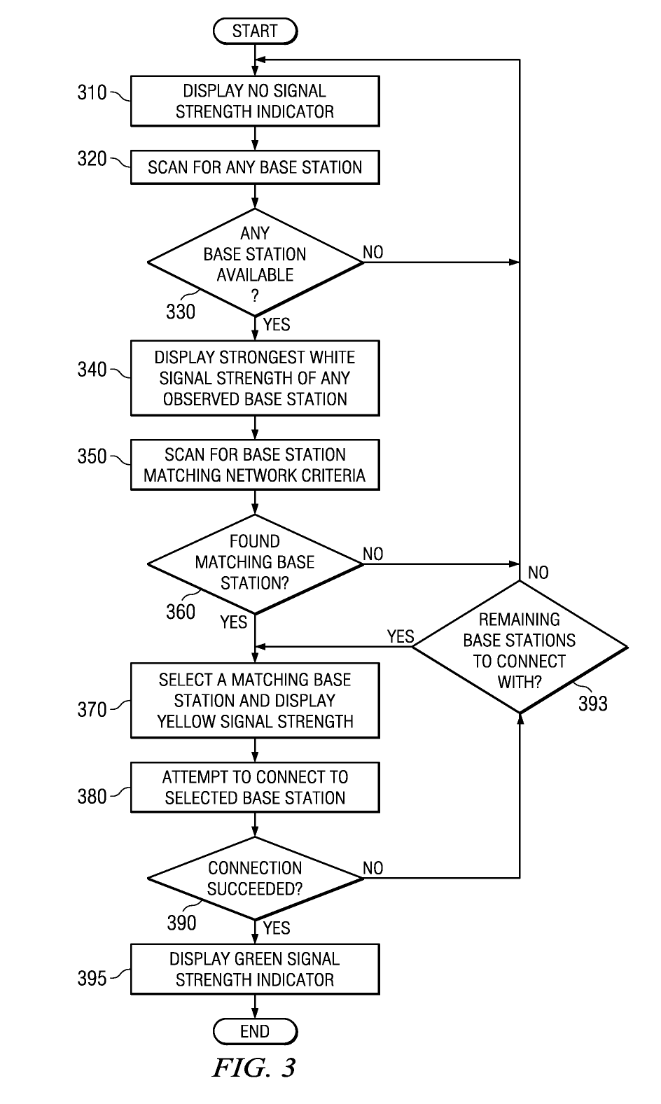

FIG. 3 illustrates an example method for indicating current connection status of a wireless device 180. In general, the steps illustrated in FIG. 3 may be combined, modified, or deleted, where appropriate, and additional steps may also be added to the example operation. Furthermore, the described steps may be performed in any suitable order. The method starts at step 310, where a nothing-found indicator is displayed at a wireless device 180. In particular embodiments, this may occur after wireless device 180 has been turned on (or its radio functionality turned on) or after wireless device 180 has lost a wireless connection with a wireless network. For example, wireless device 180 may have roamed outside of the range of a wireless network to which wireless device 180 was connected. This may also occur before a scan of available base stations or access points has been made. At step 320, wireless device 180 may perform a scan to detect any available base stations (or access points or wireless networks). At step 330, wireless device 180 may analyze the results of the scan. This analysis may be done during or after the scan. If no base stations are detected as result of the analysis in step 330, wireless device 180 may display the nothing-found indicator as in step 310.

In particular embodiments, the scan at step 320, may be a passive scan. This may mean that a probe request was not transmitted, but wireless device 180 only listened for beacons. This may be done for regulatory reasons. In particular embodiments, the scan may be done actively with an empty SSID that matches all access points (or available networks). The scan results may contain access points from multiple disjoint networks, or networks to which wireless device 180 may not be configured to connect, as well as configured ones. As the SSID may be withheld from the beacon, it may not always possible to distinguish which access point is a part of the one or more networks wireless device 180 may be pre-configured to access. Hence, the display of white bars in a scan-result indicator (as discussed further below) may indicate an access point or wireless network with the highest signal strength, but wireless device 180 may not have identified if the access point is apart of the wireless networks wireless device 180 may be pre-configured to connect to.

At step 340, a scan-result indicator indicating that one or more wireless networks are available may be displayed in response to the determination at step 330. In particular embodiments, this may indicate that wireless device 180 has detected the existence of the networks but has not yet attempted to establish a wireless connection with any of the detected networks (as discussed further below). The scan-result indicator displayed at step 340 may be different than the indicator displayed at step 310. For example, the scan-result indicator displayed at step 340 may contain a different color than the indicator displayed at step 330. In particular embodiments, the indicators may be different icons or different sounds that may be played. In particular embodiments, status representations 210 and 220 of FIGS. 2A and 2B may be utilized: status representation 210 may be displayed at step 340 and status representation 220 may be displayed at step 310. For example, the scan-result indicator may include status representation 210 with selected bars filled in with a white color to indicate the strength of the received signal from the available network that has the highest signal quality of the detected networks.

At step 350, in particular embodiments, wireless device 180 may scan for a base station that matches one or more network criteria stored in wireless device 180. The scanning process may proceed by sending probe requests to the channels where access points have been observed. The probe request may contain a configured SSID of wireless device 180 that is used to discriminate among the various wireless networks. Wireless device 180, in particular embodiments, may also transmit other forms of identification or authentication information as may be suitable in a variety of wireless network contexts, such as WiMAX, Wi-Fi, Bluetooth, etc. Examples of suitable wireless contexts may be drawn from the description of FIG. 1 above.

At step 360, in particular embodiments, wireless device 180 may determine if any base stations match the criteria used in the scan of step 350. Only those access points which are configured with the same (matching) SSID, in this example, will respond to the probe request with a probe response containing the SSID in the probe response. This list may be sorted based on signal strength from the highest to the lowest. If wireless device 180 determines that there are no matching base stations, wireless device 180 may proceed back to step 310. In particular embodiments, this may include displaying the nothing-found indicator. Hence, in some embodiments, if wireless device 180 only detects base stations that it is not configured to connect with, a user of wireless device 180 may see nothing-found indicator as in step 310, then see scan-result indicator 340, and then see nothing found indicator at step 310 once again since no matching base stations were detected. In some embodiments, wireless device 180 may be configured to toggle between these two indicators if no matching base stations are detected. In particular embodiments, wireless device 180 may be configured to only show scan-result indicator. This may occur, for example, if wireless device 180 detects that the only base stations it is detecting at step 330 are base stations it has already determined are not matching base stations at step 360.

At step 370, in particular embodiments, wireless device 180 may determine a base station that wireless device 180 will attempt to establish a wireless connection with. The base station (or access point or wireless network or wireless infrastructure) may be determined based on the results of the determination at step 360. A connection-attempt indicator representing that wireless device 180 is attempting to establish a wireless connection with a wireless network may be presented. The connection-attempt indicator may be different in at least one aspect from the indicators displayed at steps 310 and 340. For example, the indicator displayed at step 370 may contain a different color from the indicators displayed at steps 310 and 340. In particular embodiments, the connection-attempt indicator presented at step 370 may be an audible indicator different than the indicators presented at steps 310 and 340. The connection-attempt indicator may be displayed with yellow bars corresponding to the signal strength from the base station with which wireless device 180 is attempting to establish a connection. At step 380, in particular embodiments, wireless device 180 may attempt to connect to the selected base station. The connection-attempt indicator may remain displayed on wireless device 180 until one or more steps of the attempt establish a connection with the wireless network are completed. For example, wireless device 180 may undergo one or more authentication procedures as part of the attempt to establish a wireless connection with the wireless network. During these authentication procedures, the connection-attempt indicator may be displayed.

At step 390, in particular embodiments, wireless device 180 may determine if a wireless connection has been established between wireless device 180 and the selected base station (or access point or wireless network or wireless infrastructure). If the wireless connection has been established to a wireless network, then a connected indicator may be presented at step 395 that indicates that a wireless connection has been established with the selected base station, at which point the method may end. The connected indicator may be different in at least one aspect from the indicators displayed at steps 310, 340, and 370. For example, the connected indicator displayed at step 395 may contain a different color from the indicators displayed at steps 310, 340, and 370. Hence, the connected indicator may include bars that have a green color in a manner that corresponds to the signal strength received from the base station. In particular embodiments, the connected indicator presented at step 380 may be an audible indicator different than the indicators presented at steps 310, 340, and 370.

If a wireless connection has not been established with the selected base station, then wireless device 180 may proceed to step 393 to determine if there are other base stations that wireless device 180 may connect with. If there are remaining base stations to connect with, wireless device 180 may proceed to step 370 and attempt to establish a connection with the other base stations. The connection-attempt indicator may be displayed. If there are not any other base stations to connect with, wireless device 180 may proceed to step 310. In some embodiments, this may allow wireless device 180 to detect other base stations it may not have detected during the initial scan at step 320. A user of wireless device 180 may be presented with the following sequence of indicators if wireless device 180 proceeds from step 393 to step 310: nothing-found indicator (initial entrance to step 310), scan-result indicator (step 340), connection-attempt indicator (step 370), nothing-found indicator (second entrance to step 310 as a result of the determination at step 393), scan-result indicator (second entrance to step 340), connection-attempt indicator (second entrance to step 370), etc. In some embodiments, a user and/or technician may be able to observe the sequence and diagnose any errors that may have occurred.

In particular embodiments, wireless device 180 may reenter step 310 and proceed in the same manner as before, arriving at step 393 multiple times due to the inability to connect to any of the matching base stations. In such situations, wireless device 180 may be configured to stop returning to step 310 and display the connection-attempt indicator. Wireless device 180 may use counters and thresholds to determine when to stop returning to step 310 from step 393.

In particular embodiments, one or more errors may be present that prevents wireless device 180 from establishing a wireless connection with any available base station. In such situations, the connection-attempt indicator may remain displayed or altered according to the signal strength received from the other selected base station. This may provide a user of wireless device 180 or a technician with an indication that an error occurred during the attempt to establish a wireless connection with a wireless network.

The indicators discussed above with respect to FIG. 3, may, in particular embodiments, be implemented using status representations 210 and 220 discussed above with respect to FIGS. 2A and 2B. Status representations 210 and 220 may be modified as may be suitable for the steps discussed in FIG. 3. For example, status representation 220 may be used at step 310 such that the nothing-found indicator may include a red slash or “X” over a set of bars. Status representation 210 may be used at step 340 such that status representation 210 contains the color white. Status representation 210 may also be used at steps 370 and 395, using colors yellow and green for each of the respective states. For example, connection-attempt indicator may include status representation 210 with a selected set of bars filled with a yellow color indicating the quality of received signals from the base station with which wireless device 180 is trying to connect. As another example, the connected indicator may include status representation 210 with a selected set of the bars colored green such that it indicates the quality of received signals from the base station wireless device 180 is connected to. Other suitable implementations of indicators may also be used alone or in combination with the indicators discussed above.

In particular embodiments, the embodiments described above may allow a user to troubleshoot a few problems. If the user misconfigured an SSID, they would see that wireless device 180 can see access points, just that they do not match, as they would only see white bars. If the user sees white bars followed by yellow bars, the user could determine that the SSID does match, but some other impediments prevent a connection from being established such as authentication failures. In the situation where wireless device 180 attempts to establish a connection with more than one base station, the user may see connection-attempt indicator with the number of bars colored yellow decreasing. For example, wireless device 180 may attempt to connect to three successive base stations, one with a high signal strength, one with a medium signal strength, and one with a low signal strength. When wireless device 180 attempts to establish a connection with the base station that has the highest signal strength, the user may observe a connection-attempt indicator with three yellow bars. Later, when wireless device 180 attempts to connect with the base station with a medium signal strength, the user may observe a connection-attempt indicator with two yellow bars. Finally, when wireless device 180 attempts to connect with the base station with a low signal strength, the user may observe a connection-attempt indicator with only one yellow bar. Hence, the user may observe a connection-attempt indicator which has the number of yellow bars change (count down) as wireless device 180 attempts to connect to several base stations. Also, it may be known that wireless device 180 has successfully sent probe requests, as the base station may have received and sent a probe response.

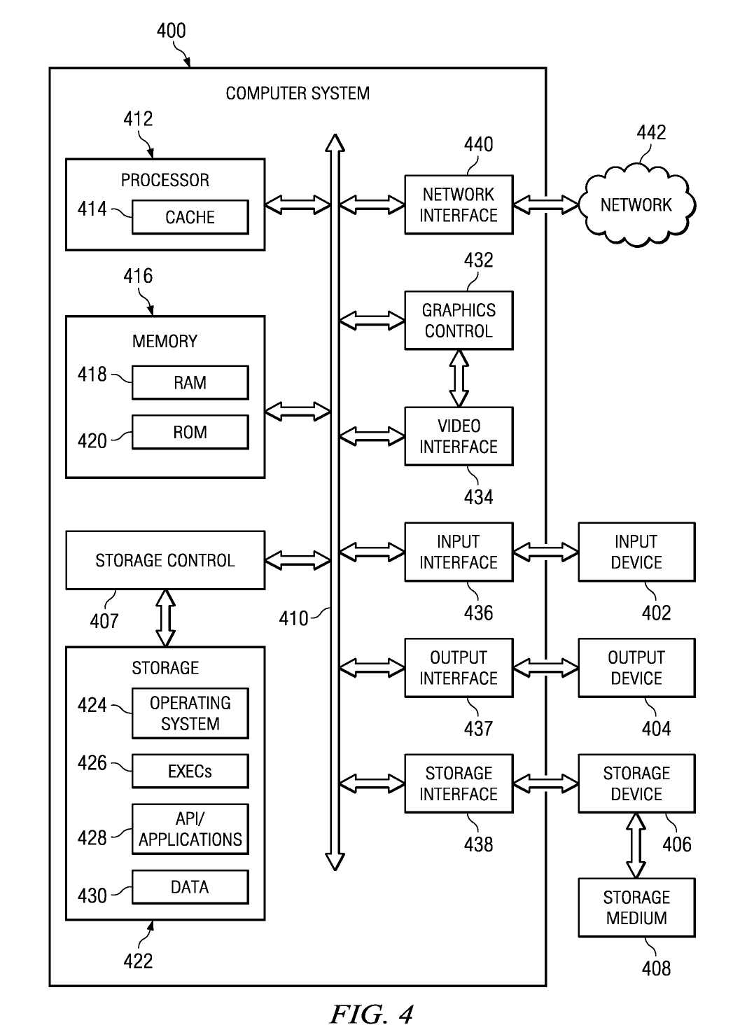

FIG. 4 illustrates an example computer system 400 suitable for implementing one or more portions of particular embodiments. Although the present disclosure describes and illustrates a particular computer system 400 having particular components in a particular configuration, the present disclosure contemplates any suitable computer system having any suitable components in any suitable configuration. Moreover, computer system 400 may have take any suitable physical form, such as for example one or more integrated circuit (ICs), one or more printed circuit boards (PCBs), one or more handheld or other devices (such as mobile telephones or PDAs), one or more personal computers, or one or more super computers. Wireless device 180s, access points, and other components discussed above with respect to FIG. 1 may be implemented using all of the components, or any appropriate combination of the components, of computer system 400 described below.

Computer system 400 may have one or more input devices 402 (which may include a keypad, keyboard, mouse, stylus, etc.), one or more output devices 404 (which may include one or more displays, one or more speakers, one or more printers, etc.), one or more storage devices 406, and one or more storage medium 408. An input device 402 may be external or internal to computer system 400. An output device 404 may be external or internal to computer system 400. A storage device 406 may be external or internal to computer system 400. A storage medium 408 may be external or internal to computer system 400.

System bus 410 couples subsystems of computer system 400 to each other. Herein, reference to a bus encompasses one or more digital signal lines serving a common function. The present disclosure contemplates any suitable system bus 410 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 400 includes one or more processors 412 (or central processing units (CPUs)). A processor 412 may contain a cache 414 for temporary local storage of instructions, data, or computer addresses. Processors 412 are coupled to one or more storage devices, including memory 416. Memory 416 may include random access memory (RAM) 418 and read-only memory (ROM) 420. Data and instructions may transfer bidirectionally between processors 412 and RAM 418. Data and instructions may transfer unidirectionally to processors 412 from ROM 420. RAM 418 and ROM 420 may include any suitable computer-readable storage media.

Computer system 400 includes fixed storage 422 coupled bi-directionally to processors 412. Fixed storage 422 may be coupled to processors 412 via storage control unit 407. Fixed storage 422 may provide additional data storage capacity and may include any suitable computer-readable storage media. Fixed storage 422 may store an operating system (OS) 424, one or more executables (EXECs) 426, one or more applications or programs 428, data 430 and the like. Fixed storage 422 is typically a secondary storage medium (such as a hard disk) that is slower than primary storage. In appropriate cases, the information stored by fixed storage 422 may be incorporated as virtual memory into memory 416.

Processors 412 may be coupled to a variety of interfaces, such as, for example, graphics control 432, video interface 434, input interface 436, output interface 437, and storage interface 438, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 440 may couple processors 412 to another computer system or to network 442. Network interface 440 may include wired, wireless, or any combination of wired and wireless components. Such components may include wired network cards, wireless network cards, radios, antennas, cables, or any other appropriate components. With network interface 440, processors 412 may receive or send information from or to network 442 in the course of performing steps of particular embodiments. Particular embodiments may execute solely on processors 412. Particular embodiments may execute on processors 412 and on one or more remote processors operating together.

In a network environment, where computer system 400 is connected to network 442, computer system 400 may communicate with other devices connected to network 442. Computer system 400 may communicate with network 442 via network interface 440. For example, computer system 400 may receive information (such as a request or a response from another device) from network 442 in the form of one or more incoming packets at network interface 440 and memory 416 may store the incoming packets for subsequent processing. Computer system 400 may send information (such as a request or a response to another device) to network 442 in the form of one or more outgoing packets from network interface 440, which memory 416 may store prior to being sent. Processors 412 may access an incoming or outgoing packet in memory 416 to process it, according to particular needs.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, optical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 416 may include one or more computer-readable storage media embodying software and computer system 400 may provide particular functionality described or illustrated herein as a result of processors 412 executing the software. Memory 416 may store and processors 412 may execute the software. Memory 416 may read the software from the computer-readable storage media in mass storage device 416 embodying the software or from one or more other sources via network interface 440. When executing the software, processors 412 may perform one or more steps of one or more processes described or illustrated herein, which may include defining one or more data structures for storage in memory 416 and modifying one or more of the data structures as directed by one or more portions the software, according to particular needs. In addition or as an alternative, computer system 400 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

1. A method comprising:
determining by one or more processing elements a current connection status of a first wireless device with respect to one or more second wireless devices configured to communicate wirelessly by a particular wireless communication protocol, the current connection status of the first wireless device potentially comprising:
the first wireless device having scanned for and found one or more available ones of the second wireless devices to connect wirelessly to but not yet having established a wireless connection to any one of them, each of the available ones of the second wireless devices having a signal strength with respect to the first wireless device; or
the first wireless device currently attempting to establish a wireless connection to one of the available ones of the second wireless devices; and
communicating by the one or more processing elements for presentation to a user at the first wireless device:
a scan-result indicator if the first wireless device has scanned for and found one or more available ones of the second wireless devices to connect wirelessly to but has not yet established a wireless connection to any one of them, the scan-result indicator indicating a level of a highest one of the signal strengths of the available ones of the second wireless devices with respect to the first wireless device; and
a connection-attempt indicator if the first wireless device currently is attempting to establish a wireless connection to one of the available ones of the second wireless devices, the connection-attempt indicator indicating a level of the signal strength with respect to the first wireless device of the one of the available ones of the second wireless devices that the first wireless device currently is attempting to establish a wireless connection to.

2. The method of claim 1, wherein:
the current connection status of the first wireless device further potentially comprises:
there currently being no available one of the second wireless devices for the first wireless device to connect wirelessly to; or
the first wireless device currently being connected wirelessly to one of the available ones of the second wireless devices; and
the method further comprises communicating by the one or more processing elements for presentation to a user at the first wireless device:
a nothing-found indicator if there is currently no available one of the second wireless devices for the first wireless device to connect wirelessly to; and
a connected indicator if the first wireless device currently is connected wirelessly to one of the available ones of the second wireless devices, the connected indicator indicating a level of the signal strength with respect to the first wireless device of the one of the available ones of the second wireless devices that the first wireless device currently is wirelessly connected to.

3. The method of claim 2, wherein:
the nothing-found indicator comprises a red slash mark;
the scan-result indicator comprises one or more white signal-strength indicating bars collectively indicating the level of the highest one of the signal strengths of the available ones of the second wireless devices with respect to the first wireless device;
the connection-attempt indicator comprises one or more yellow signal-strength indicating bars collectively indicating the level of the signal strength with respect to the first wireless device of the one of the available ones of the second wireless devices that the first wireless device currently is attempting to establish a wireless connection to; and
the connected indicator comprises one or more green signal-strength indicating bars collectively indicating the level of the signal strength with respect to the first wireless device of the one of the available ones of the second wireless devices that the first wireless device currently is wirelessly connected to.

4. The method of claim 1, wherein:
the first wireless device is a Wi-Fi enabled mobile telephone;
the second wireless devices are Wi-Fi access points (APs); and
the particular wireless communication protocol is a Wi-Fi wireless communication protocol.

5. The method of claim 1, wherein:
the first wireless device is a BLUETOOTH-enabled wireless peripheral; and
the particular wireless communication protocol is a BLUETOOTH wireless communication protocol.

6. The method of claim 1, wherein the second wireless devices collectively compose an ad-hoc network.

7. The method of claim 1, wherein the first wireless device currently attempting to establish a wireless connection to one of the available ones of the second wireless devices comprises the first wireless device determining a service set identifier (SSID) associated with the available one of the second wireless devices.

8. The method of claim 1, wherein the first wireless device currently attempting to establish a wireless connection to one of the available ones of the second wireless devices comprises the first wireless device attempting to enter a network that comprises the available one of the second wireless devices.

9. The method of claim 1, wherein the first wireless device currently attempting to establish a wireless connection to one of the available ones of the second wireless devices comprises the first wireless device attempting to authenticate itself to the available one of the second wireless devices.

10. The method of claim 1, wherein:
the connection-attempt indicator is communicated prior to authentication of the first wireless device to one of the available ones of the second wireless devices; and
the connected indicator is communicated is after association of the first wireless device with one of the available ones of the second wireless devices.

11. An apparatus comprising:
a wireless communication interface;
a memory storing instructions for execution by one or more processors; and
one or more processors coupled to the memory, the processors being operable when executing the instructions to:
determine a current connection status of a first wireless device with respect to one or more second wireless devices configured to communicate wirelessly by a particular wireless communication protocol, the current connection status of the first wireless device potentially comprising:
the first wireless device having scanned for and found one or more available ones of the second wireless devices to connect wirelessly to but not yet having established a wireless connection to any one of them, each of the available ones of the second wireless devices having a signal strength with respect to the first wireless device; or
the first wireless device currently attempting to establish a wireless connection to one of the available ones of the second wireless devices; and
communicate for presentation to a user at the first wireless device:
a scan-result indicator if the first wireless device has scanned for and found one or more available ones of the second wireless devices to connect wirelessly to but has not yet established a wireless connection to any one of them, the scan-result indicator indicating a level of a highest one of the signal strengths of the available ones of the second wireless devices with respect to the first wireless device; and
a connection-attempt indicator if the first wireless device currently is attempting to establish a wireless connection to one of the available ones of the second wireless devices, the connection-attempt indicator indicating a level of the signal strength with respect to the first wireless device of the one of the available ones of the second wireless devices that the first wireless device currently is attempting to establish a wireless connection to.

12. The apparatus of claim 11, wherein:
the current connection status of the first wireless device further potentially comprises:
there currently being no available one of the second wireless devices for the first wireless device to connect wirelessly to; or
the first wireless device currently being connected wirelessly to one of the available ones of the second wireless devices; and
the processors are further operable when executing the instructions to communicate for presentation to a user at the first wireless device:
a nothing-found indicator if there is currently no available one of the second wireless devices for the first wireless device to connect wirelessly to; and
a connected indicator if the first wireless device currently is connected wirelessly to one of the available ones of the second wireless devices, the connected indicator indicating a level of the signal strength with respect to the first wireless device of the one of the available ones of the second wireless devices that the first wireless device currently is wirelessly connected to.

13. The apparatus of claim 12, wherein:
the nothing-found indicator comprises a red slash mark;
the scan-result indicator comprises one or more white signal-strength indicating bars collectively indicating the level of the highest one of the signal strengths of the available ones of the second wireless devices with respect to the first wireless device;
the connection-attempt indicator comprises one or more yellow signal-strength indicating bars collectively indicating the level of the signal strength with respect to the first wireless device of the one of the available ones of the second wireless devices that the first wireless device currently is attempting to establish a wireless connection to; and
the connected indicator comprises one or more green signal-strength indicating bars collectively indicating the level of the signal strength with respect to the first wireless device of the one of the available ones of the second wireless devices that the first wireless device currently is wirelessly connected to.

14. The apparatus of claim 11, wherein:
the first wireless device is a Wi-Fi enabled mobile telephone;
the second wireless devices are Wi-Fi access points (APs); and
the particular wireless communication protocol is a Wi-Fi wireless communication protocol.

15. The apparatus of claim 11, wherein:
the first wireless device is a BLUETOOTH-enabled wireless peripheral; and
the particular wireless communication protocol is a BLUETOOTH wireless communication protocol.

16. The apparatus of claim 11, wherein the second wireless devices collectively compose an ad-hoc network.

17. The apparatus of claim 11, wherein the first wireless device currently attempting to establish a wireless connection to one of the available ones of the second wireless devices comprises the first wireless device determining a service set identifier (SSID) associated with the available one of the second wireless devices.

18. The apparatus of claim 11, wherein the first wireless device currently attempting to establish a wireless connection to one of the available ones of the second wireless devices comprises the first wireless device attempting to enter a network that comprises the available one of the second wireless devices.

19. The apparatus of claim 11, wherein the first wireless device currently attempting to establish a wireless connection to one of the available ones of the second wireless devices comprises the first wireless device attempting to authenticate itself to the available one of the second wireless devices.

20. The apparatus of claim 11, wherein:
the connection-attempt indicator is communicated prior to authentication of the first wireless device to one of the available ones of the second wireless devices; and
the connected indicator is communicated is after association of the first wireless device with one of the available ones of the second wireless devices.

21. One or more computer-readable storage media compromising instructions for execution by one or more processors, the one or more processors being operable when executing the instructions to:
determine a current connection status of a first wireless device with respect to one or more second wireless devices configured to communicate wirelessly by a particular wireless communication protocol, the current connection status of the first wireless device potentially comprising:
the first wireless device having scanned for and found one or more available ones of the second wireless devices to connect wirelessly to but not yet having established a wireless connection to any one of them, each of the available ones of the second wireless devices having a signal strength with respect to the first wireless device; or
the first wireless device currently attempting to establish a wireless connection to one of the available ones of the second wireless devices; and
communicate for presentation to a user at the first wireless device:
a scan-result indicator if the first wireless device has scanned for and found one or more available ones of the second wireless devices to connect wirelessly to but has not yet established a wireless connection to any one of them, the scan-result indicator indicating a level of a highest one of the signal strengths of the available ones of the second wireless devices with respect to the first wireless device; and
a connection-attempt indicator if the first wireless device currently is attempting to establish a wireless connection to one of the available ones of the second wireless devices, the connection-attempt indicator indicating a level of the signal strength with respect to the first wireless device of the one of the available ones of the second wireless devices that the first wireless device currently is attempting to establish a wireless connection to.
